(19) United States
(12) Patent Application Publication
(10) Pub. No.: US 2013/0271978 A1
(43) Pub. Date: Oct. 17, 2013

(54) LARGE-SCALE PRISM LUMINAIRES

(71) Applicant: Carl Gould, Golden, CO (US)

(72) Inventor: Carl Gould, Golden, CO (US)

(21) Appl. No.: 13/447,809

(22) Filed: Apr. 16, 2012

(51) Int. Cl. F21V 5/02; F21V 5/04; F21V 7/00

(52) U.S. Cl. 362/235; 362/311.01; 362/311.06; 362/341

(57) ABSTRACT

Embodiments of the invention include luminaires with a large-scale prism. In some embodiments, a large-scale prism can be any prism with a base having the smallest dimension greater than one half of an inch. In some embodiments, a large-scale prism can be any prism with a base having the smallest dimension between two and four inches. At these large-scales, the geometry of the individual prism can be easily appreciated through casual observation. Use of large-scale prisms can provide a light without high angle glare.

### FIELD

The present subject matter relates generally to luminaires that employ large-scale prisms.

### BACKGROUND

Prismatic sheets, such as those shown in FIG. 1, are commonly used to control the high angle brightness (and thus reduce the glare) of luminaires using light sources with a wide angular distribution. These sheets can have a plurality of small prisms arrayed along at least one side of the sheet as described in U.S. Pat. No. 2,474,317. These prisms can prevent light from exiting at shallow angles relative to the plane of the sheet. Used in conjunction with a luminaire employing tubular fluorescent lamping, a prismatic sheet can significantly reduce the light output of a ceiling mounted luminaire at high angles measured relative to nadir. This behavior is referred to as “cut-off”. This name stems from the fact that light output is cut off (in practice, greatly reduced) above (closer to horizontal) a given viewing angle—known as the cutoff angle. The purpose of these prismatic sheets is to limit the glare potential of the luminaire when viewed at normal gazing angles near to horizontal. Due to imprecision in the manufacture of prismatic sheet, the cut-off behavior occurs over angular ranges rather than at a precise angle.

### BRIEF SUMMARY

Embodiments of the invention are directed toward luminaires employing a large-scale prism. This prism can provide a cut-off angle that significantly reduces glare from light sources within the luminaire. A large-scale prism can be any type of prism, the smallest diameter of which can be greater than 1 inch. One or more light sources and/or a patterning lens can be used in conjunction with the large-scale prism. The light sources and/or the patterning lens can be disposed relative to the prism with an air gap in between.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are, further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE DRAWINGS

Illustrative embodiments of the present invention are described in detail below with reference to the following figures:

FIG. 1 is an illustration of the McPhail prism pattern that exists in the prior art.

FIG. 2A shows a male conical large-scale prism according to some embodiments of the invention.

FIG. 2B shows a male, pyramidal, large-scale prism according to some embodiments of the invention.

FIG. 2C shows a male, linear, large-scale prism according to some embodiments of the invention.

FIG. 3A shows a female, conical, large-scale prism according to some embodiments of the invention.

FIG. 3B shows a female, pyramidal, large-scale prism according to some embodiments of the invention.

FIG. 3C shows a female, linear, large-scale prism according to some embodiments of the invention.

FIG. 4A shows a male, linear, large-scale prism with beveled edges according to some embodiments of the invention.

FIG. 4B shows a truncated, female, pyramidal, large-scale prism according to some embodiments of the invention.

FIG. 4C shows a truncated, male, conical, large-scale prism according to some embodiments of the invention.

FIG. 5A shows a side-view of a large-scale prism along with reverse vision rays at low viewing angles according to some embodiments of the invention.

FIG. 5B shows a side-view of a large-scale prism along with reverse vision rays at high viewing angles according to some embodiments of the invention.

FIGS. 6A, 6B, and 6C show a linear large-scale prism viewed in a flashed, partially-flashed and an unflashed viewing angle.

FIGS. 7A, 7B and 7C show a luminaire with a linear large-scale prism viewed in a a flashed, partially-flashed and an unflashed viewing angle.

FIG. 8 shows a typical luminous intensity profile of a cut-off luminaire.

FIG. 9 shows a side-view of a large-scale prism with a ribbed refractor according to some embodiments of the invention.

FIG. 10 shows a side-view of a large-scale prism with a ribbed refractor and a plurality of LEDs according to some embodiments of the invention.

FIG. 11 shows a male, linear, large-scale prism in a pendant configuration according to some embodiments of the invention.

FIG. 12A shows a male conical large-scale prism in a pendant configuration according to some embodiments of the invention.

FIG. 12B shows a female conical large-scale prism in a pendant configuration according to some embodiments of the invention.

FIG. 13 shows a side-view of a linear large-scale prism designed for side configurations according to some embodiments of the invention.

FIG. 14 shows a plurality of male, linear, large-scale prisms arranged in an array according to some embodiments of the invention.

FIG. 15 shows a side-view of a large-scale cuboid with a ribbed refractor according to some embodiments of the invention.

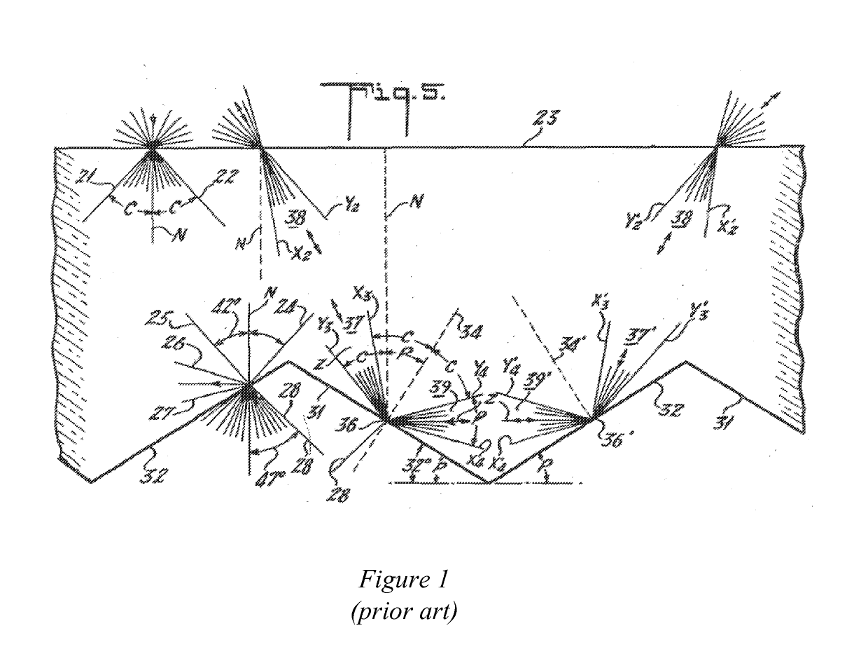

### DETAILED DESCRIPTION OF THE INVENTION

The subject matter of embodiments of the present invention is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Like numerals within the drawings and mentioned herein represent substantially identical structural elements. Each example is provided by way of explanation, and not as a limitation. For instance, features illustrated or described as part of one embodiment may be used on another embodiment to yield a further embodiment. Thus, it is intended that this disclosure includes modifications and variations.

Embodiments of the invention include luminaires with a single large-scale cut-off prism that can be formed in a variety of geometric shapes. A large-scale prism can be any prism with a base having the smallest dimension greater than one half of an inch. In some embodiments, a large-scale prism can be any prism with a base having the smallest dimension between two and six inches. In some embodiments, the base of the large-scale prism has a surface area greater than 0.25 square inches, 0.5 square inches, 1.0 square inches, 2 square inches, 5 square inches, 10 square inches, 15 square inches, 20 square inches, 25 square inches, 30 square inches, 35 square inches, 40 square inches, 45 square inches, 50 square inches, 55 square inches, 60 square inches, 65 square inches, etc. At these geometries, the individual prism can be easily appreciated through casual observation. The clarity, solidity, depth and precision of such a prism can convey a visually interesting, gem-like appearance. These prisms can be formed from any type of transparent material such as, for example, glass or acrylic.

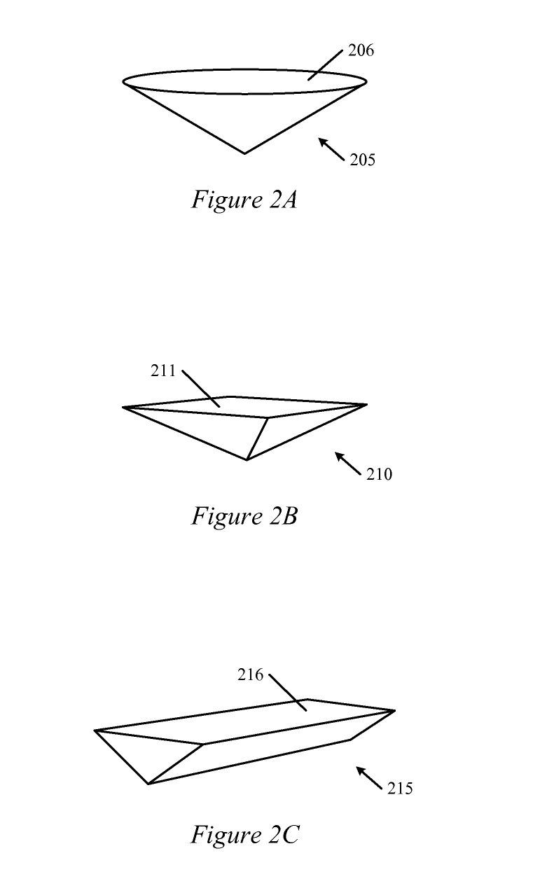

FIG. 2A shows a male, conical, large-scale prism 205 according to some embodiments of the invention. Male, conical, large-scale prism 205 includes circular base 206. In some embodiments, male, conical, large-scale prism 205 can have an oval base. The smallest diameter of the base 206 can be greater than one half of an inch. Male, conical, large-scale prism 205 may also include a height greater than one half of an inch and/or a base that has an area that is greater than 0.25 square inches.

FIG. 2B shows a male, pyramidal, large-scale prism 210 according to some embodiments of the invention. Male, pyramidal, large-scale prism 210 has a square base 211. In other embodiments male, pyramidal, large-scale prisms can have a rectangular shape, a triangular shape, or any other polygonal shape such that the smallest dimension of base 211 is greater than one half of an inch. Male, pyramidal, large-scale prism 210 may also have a height greater than one half of an inch and/or a base that has area that is greater than 0.25 square inches.

FIG. 2C shows a male, linear, large-scale prism 215 according to some embodiments of the invention. Male, linear, large-scale prism 215 has rectangular base 216 that can be much larger in one dimension than the other. Male, linear, large-scale prism 215 may also have a height greater than one half of an inch and/or a base that has an area that is greater than 0.25 square inches.

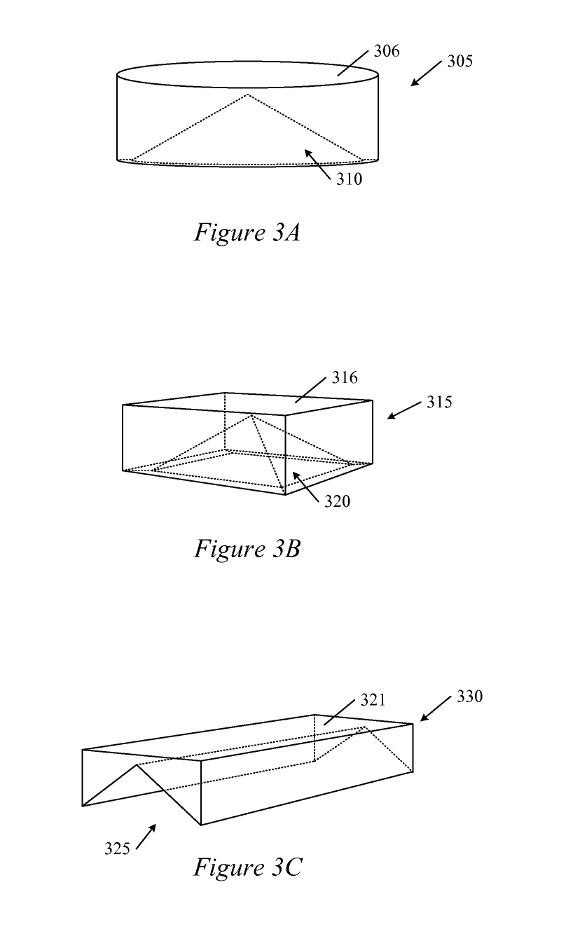

FIG. 3A shows a female, conical, large-scale prism 305 according to some embodiments of the invention. A conical shape 310 can be formed with a cylindrical block and the female, conical, large-scale prism 310 is formed within. Female, conical, large-scale prism 305 has circular base 306. In some embodiments, female, conical, large-scale prism 305 can have an oval base. The smallest diameter of the base can be greater than one half of an inch and/or base 306 can have an area that is greater than 0.25 square inches. Female, conical, large-scale prism 305 may also have a height greater than one half of an inch.

FIG. 3B shows a female, pyramidal, large-scale prism 315 according to some embodiments of the invention. A pyramidal shape 320 can be formed within a cube forming female, pyramidal, large-scale prism 315. Female, pyramidal, large-scale prism 315 has a square base 316. In other embodiments female, pyramidal, large-scale prisms can have a rectangular shape, a triangular shape, or any other polygonal shape such that the smallest dimension of base 316 is greater than one half of an inch and/or the surface area of base 316 is greater than 0.25 square inches. Female, pyramidal, large-scale prism 315 may also have a height greater than one half of an inch.

FIG. 3C shows a female, linear, large-scale prism 330 according to some embodiments of the invention. A triangular trough 325 is formed within a block forming female, conical, large-scale prism 330. Female, linear, large-scale prism 330 has rectangular base 321 that is much larger in one dimension than the other. Female, linear, large-scale prism 330 may also have a height greater than one half of an inch and/or base 321 can have an area that is greater than 0.25 square inches.

Large-scale prisms can be modified in a number of ways. For example, a large-scale prism can include a curved prism base and/or face. This curvature could be used to control the speed of the flash as seen by an observer passing under the luminaire. As another example, the appearance of the prism can be embellished, for example, by frosting areas of the prism surface, bevels, adding diffusing sections (e.g., with laser etching), truncation, or other embellishments. Moreover, other base structures, such as a triangle, pentagon, hexagon, or any other polygon can also provide similar photometric and visual properties. Any of these shapes can be embodied in either a male or female configuration.

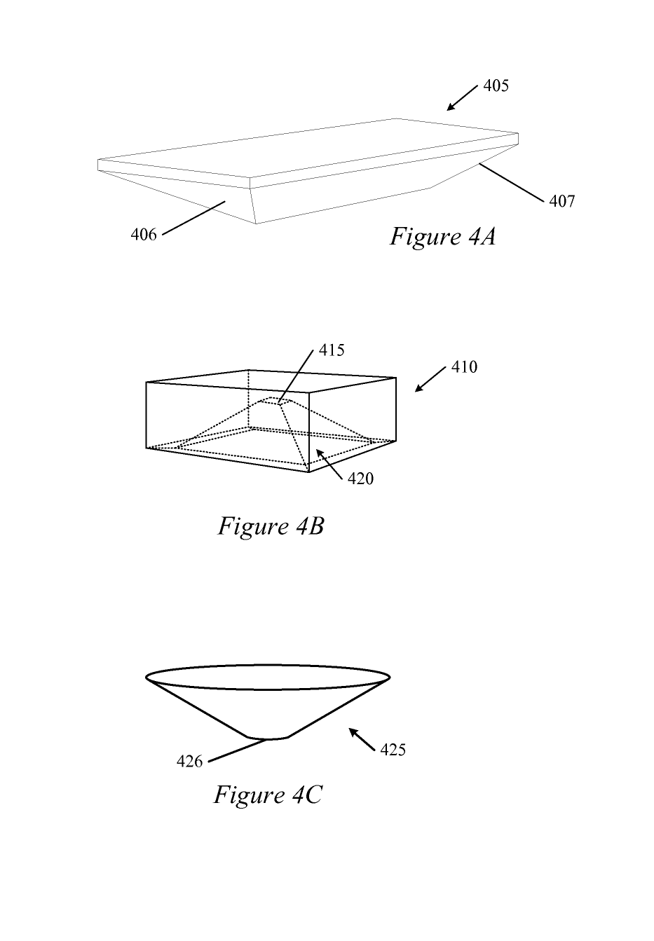

FIG. 4A shows a male, linear, large-scale prism 405 with beveled edges 406 and 407 according to some embodiments of the invention. FIG. 4B shows a female, pyramidal, large-scale prism 410 with an inverted pyramid 420 formed within a cube that has truncated tip 415. Similarly, FIG. 4C shows a male, conical, large-scale prism 425 having truncated tip 426.

In some embodiments, a large-scale prism base can have a pattern applied to it in any number of ways. For example, a pattern can be etched, painted, and/or applied to the base. While this could create a less precise cutoff behavior relative to a planar base, it may provide a means of reducing the visual abruptness of a prism's flash characteristics. Transition from a flashed to an unflashed state could become more of a gradated (as opposed to on/off) visual effect.

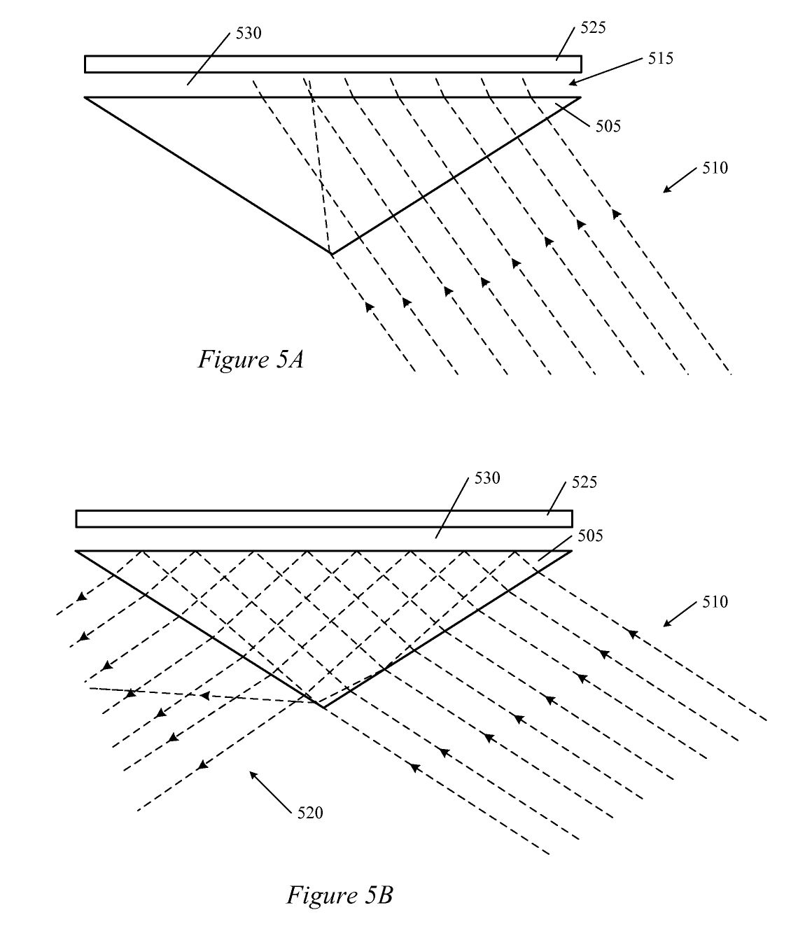

FIGS. 5A and 5B show light source 525 positioned above large scale prism 505. As shown in both figures, light source 525 can be disposed near the base of large-scale prism 505 with air gap 530 disposed between light source 525 and large-scale prism 505. Air gap 530 can be any size so long as air gap 530 does not frustrate total internal reflectance and allows some light at high viewing angles to pass through the base.

FIG. 5A shows a side-view of large-scale prism 505 with reverse vision rays 510 at low viewing angles relative to nadir. At these low viewing angles, a viewer will see an image of light source 525. Reverse vision rays 510 shown in FIG. 5B enter large-scale prism 505 from a high viewing angles relative to nadir. At these high viewing angles a viewer cannot see an image of light source 525 because of total-internal reflection. Instead, light rays 520 are reflected off the base of large-scale prism 505.

A face of large-scale prism 505 is said to be in a “flashed” state when the prism is viewed at a low viewing angle which refracts a bright and/or luminous image of light source 525. Conversely a face of large-scale prism 505 is said to be in an “unflashed” state when viewed from a high viewing angle, as shown in FIG. 5B. In this state the viewer can see either no image of light source 525 or only a luminously weak “ghost image” of light source 525. A ghost image can be viewed in the case where light rays from the source have been greatly reduced in intensity due to multiple Fresnel reflections. Flashed viewing angles are “below” (closer to vertical) the cut-off angle of the prism. Unflashed viewing angles are “above” (closer to horizontal) the cut-off angle of the prism. The manner in which the prism's faces, at differing angles of view, do or do not refract an image of a light source or lit optical chamber adjacent to the prism base is referred to as its “flash characteristics”. In some embodiments, a prism's cut-off angle can be less than 65° measured from its nadir. In other embodiments, the cut-off angle can be less than 60°, 55°, 50°, 45°, 40°, 35°, 30°, 25°, 20°, 15°, and/or 10° from nadir.

Large-scale prism 505 can be readily observed in a transition state between being fully flashed and fully unflashed. In this way, an image of the light source behind the prism can be seen to “slide” onto, or off of a prism face as an observer's point of view moves from a position viewing the large-scale prism with a line of sight having an angle below or above the cut-off angle of the large-scale prism. The nature of this transitional behavior is also part of the prism's “flash characteristics”.

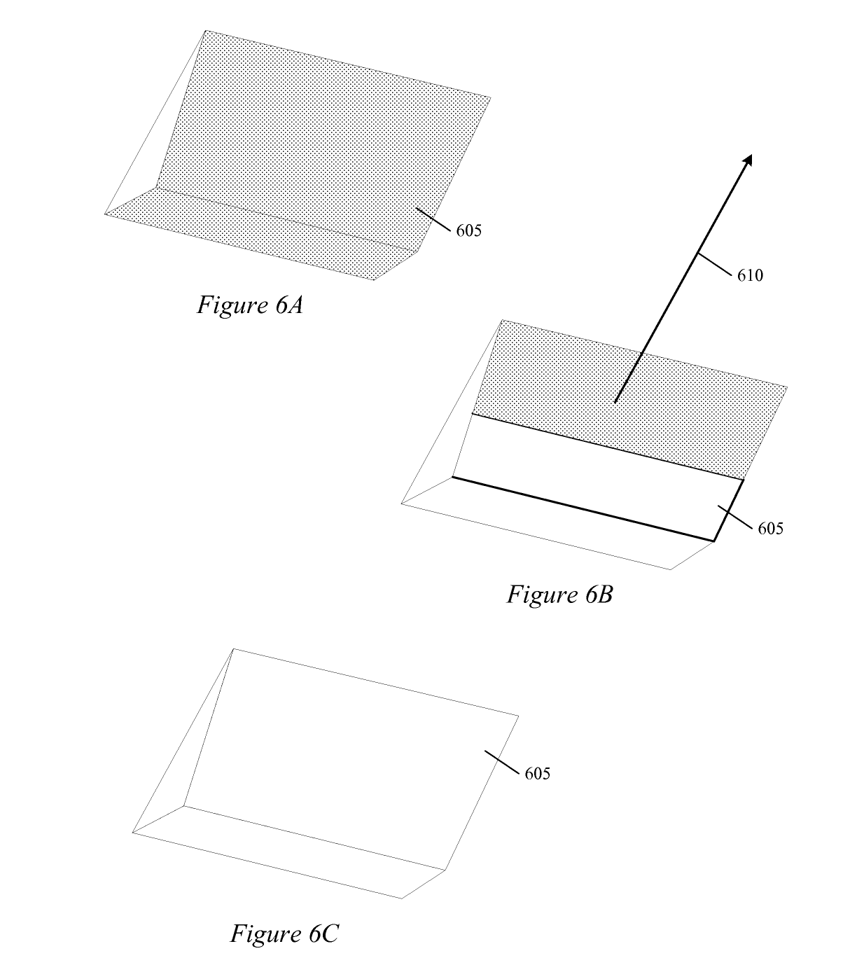

FIGS. 6A, 6B, and 6C show a transition between flashed and unflashed states of linear large-scale prism 605. FIG. 6A shows large-scale prism 605 viewed in a completely flashed state. In these figures, the shaded portions show the light source being seen through large-scale prism 605. FIG. 6B shows large-scale prism 605 in transition between the flashed and unflashed states as the viewer moves from below large-scale prism 605 to a position further away the large-scale prism 605 as indicated by arrow 610. And FIG. 6C shows large-scale prism 605 in a completely unflashed state. Large-scale prism 605 does not change physically between flashed and unflashed states. Instead, the viewer will view the large-scale prism in a flashed or unflashed state depending on their viewing angle. Thus, large-scale prism 605 has a fixed characteristic that allows it to be viewed as if it was in a flashed state or an unflashed state depending only on the position of the viewer.

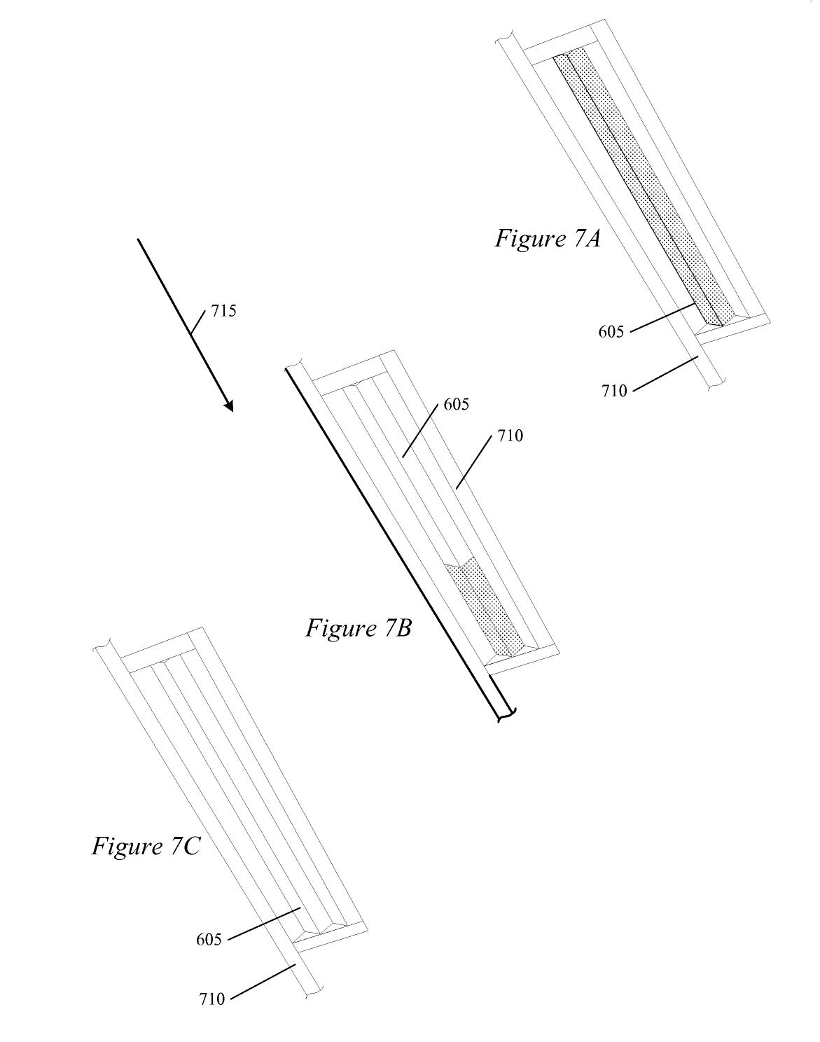

FIGS. 7A, 7B, and 7C show linear large-scale prism 605 disposed within ceiling 710 as viewed from viewing angles where the prism appears completely flashed (FIG. 7A), partially flashed (FIG. 7B), and unflashed (FIG. 7C). The partially-flashed viewing angle can be the cutoff angle. Large-scale prism 605 can be in the partially unflashed state as shown in FIG. 7B, when at the cutoff angle as a person moves from a position of high viewing angles to a position of low viewing angles.

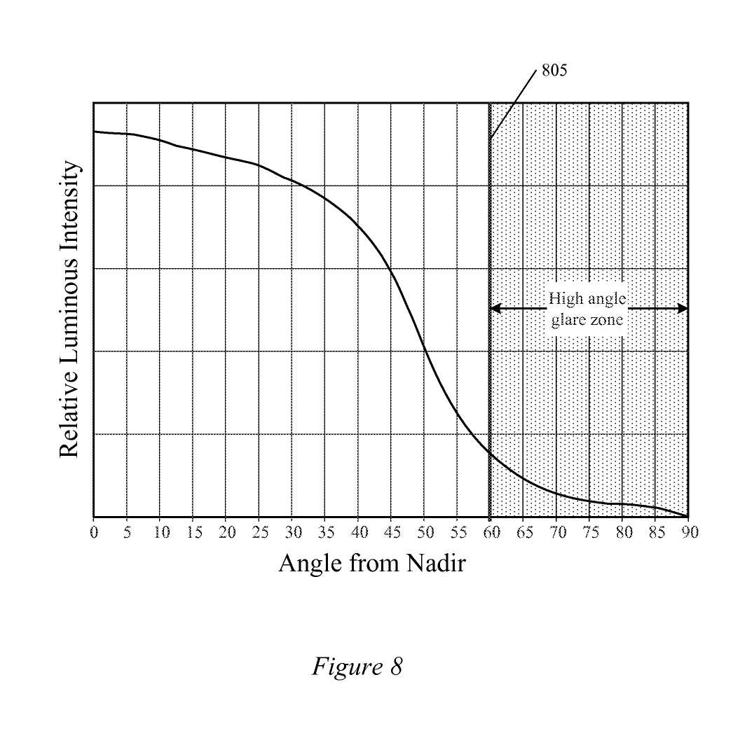

FIG. 8 shows a typical luminous intensity profile of a cut-off luminaire. The term “cut-off angle” refers to the angle above which light is cut off (or greatly reduced) or the viewing angle where the transition between being in a flashed state or an unflashed state occurs to the viewer. In FIG. 8, the cut-off 805 angle occurs at 60°. Depending on design considerations, large-scale prisms can have any number of cut-off angles. The cut-off angle of a large-scale prism can depend on the type of material the large-scale prism in made out of and geometry of the large-scale prism.

The cut-off characteristic of a large-scale prism can be important to the luminaire design in that it can minimize the potential for glare. Glare can be reduced by reducing light output in the angular zones coincident with the ordinary viewing directions of a building occupant (the so-called “glare zone”).

Because of their size, large-scale prisms 910 can have poor lamp obscuration. The term “lamp obscuration” can refer to the ability of a lens pattern to disguise or at least partially obscure the light source behind it. On its own, the size of large-scale prism 910 can prevent it from obscuring any light sources behind it. While an array of small-scale prisms acts to scramble the image of what is behind the prism base, the faces of large-scale prism 910 can display a clear and recognizable image of what lies behind the prism base (e.g., when viewed from a “flashed” angle). In some embodiments, a ready view of bare light sources can be considered unacceptable—both from an aesthetic and glare standpoint. In some embodiments, a patterning lens can be used in conjunction with a large scale prism to obscure the light source from view. Thus, in some embodiments, cut-off behavior can be achieved with large-scale prism 910 and lamp obscuration can be achieved with patterning lens 905. While a separate patterning lens 905 is shown in the figures, it is possible that the patterning lens 905 be formed directly in the base of a large-scale prism.

In some embodiments, patterning lens 905 can lay directly behind (or on top of) the base of large-scale prism 910. The cut-off behavior predicated by the flat material-to-air interface at the prism base can be maintained using patterning lens 905. Even if patterning lens 905 has a flat (non-patterned) side resting on top of the prism, an air gap 920 can be maintained that is large enough (e.g., on the order of half a wavelength or greater) so as not to frustrate the total internal reflection (TIR) at the prism base that is critical to the cut-off behavior.

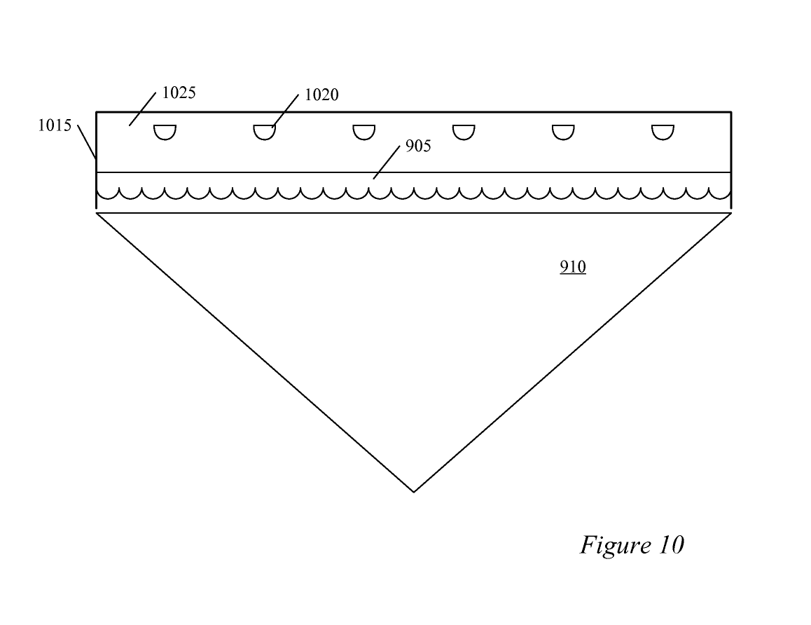

FIG. 10 shows a side-view of large-scale prism 910 with patterning lens 905 and a plurality of LEDs 1020 according to some embodiments of the invention. LEDs 1020 can be replaced with any type of light source; for example, incandescent, fluorescent, metal-halide, plasma, LED and OLED. LEDs 1020 can be disposed near patterning lens 905 and can provide light to the system. In some embodiments, patterning lens 905 can be side-lit in addition to or instead of being backlit. The original light source can be or can include natural day lighting from the sun or the sky. In some embodiments, LEDs 1020 can be arranged in a single array. In other embodiments, LEDs 1020 can be arranged in a dimensional grid.

Light from LEDs 1020 can generally be confined and/or potentially shaped, by reflective optical housing 1015. For example, reflective optical housing 1015 may be rectilinear or of a more complicated shape. Light from LEDs 1020 can be manipulated by refractive or reflective optics prior to any containment or dispersing optics.

Large-scale prism 910 can be designed, as discussed above, to minimize high-angle light output regardless of the angle at which light is input to it. In some embodiments, the efficiency with which cut-off prisms transmit light can be improved by angular shaping of the incoming light. For example, by decreasing the percentage of light at grazing incident angles and increasing the percentage of light at near normal incident angles. Such shaping can also improve the photometric distribution emanating from a large-scale prism 910. In some embodiments, the optical elements acting prior to the large-scale prism can be designed to create an angular distribution of light entering the base of the prism that is more concentrated than a Lambertian distribution of light.

Luminaires (or pendants) based on the optical engine can take on a variety of forms. They may be recessed, semi-recessed, surface, or pendent mounted. In addition they may utilize different combinations of patterning lenses, prism sizes, prism geometries, and/or prism configurations. Furthermore, reflective trim of various shapes, patterns and materials can be provided adjacent to the prism faces (examples of which are shown in FIGS. 7A, 7B and 7C).

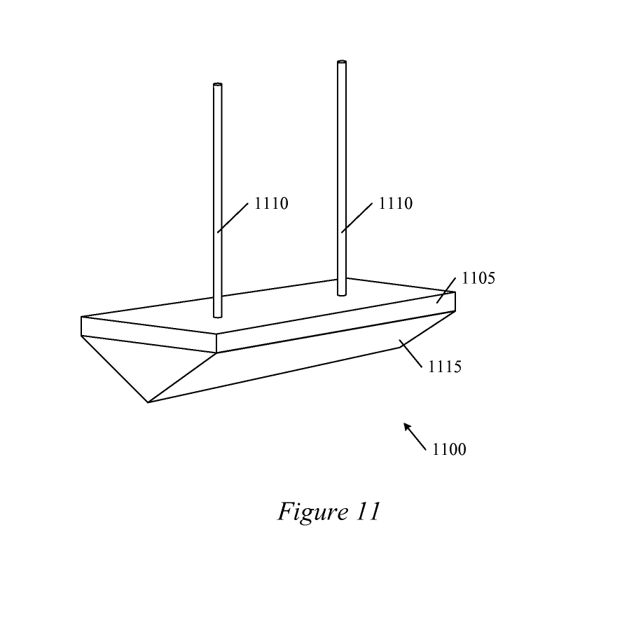

Pendant 1100 shown in FIG. 11 can include linear, large-scale prism 1115 and body 1105. Electronics, light sources (e.g., LEDs), optics, heat sinks, control circuitry, etc. can be disposed within body 1105. Pendant 1100 can include suspension mechanism 1110 from which Pendant 1100 is suspended from a ceiling. In other embodiments, a linear large-scale prism can be recessed within a ceiling.

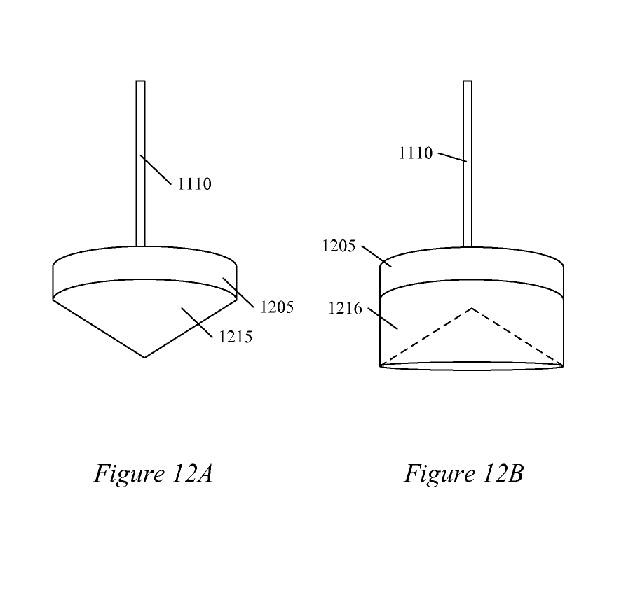

FIGS. 12A and 12B show male and female conical prism pendants. The pendants include male large-scale prism 1215 or female large-scale prism 1216, body 1205, and suspension mechanism 1110. In other embodiments, a conical (or pyramidal) large-scale prism luminaire can be recessed within a ceiling. Body 1205, for example, may house electronics, light sources (e.g., LEDs), optics, heat sinks, control circuitry, etc.

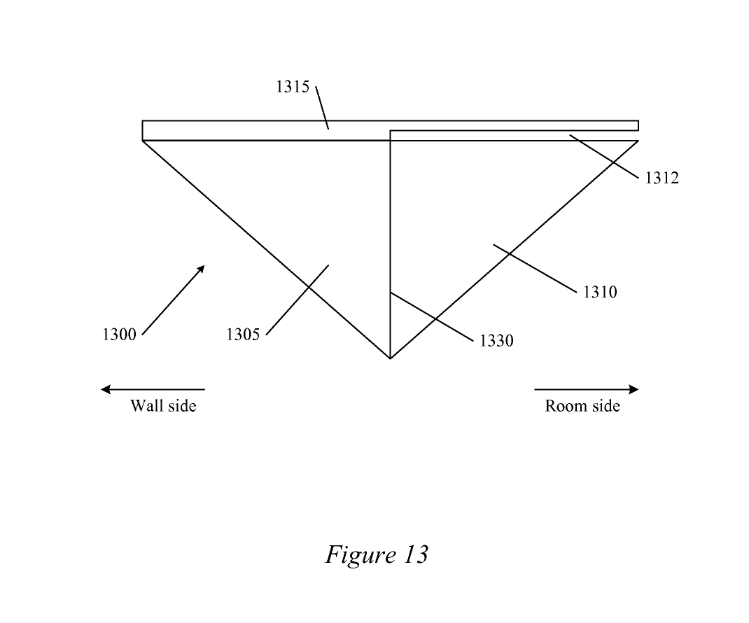

FIG. 13 shows a side-view of linear large-scale prism 1300 that can be used for wall-wash configurations according to some embodiments of the invention. Linear large-scale prism 1300 can be located close to a wall and can provide an asymmetric distribution of light. The side of the luminaire facing the room may exhibit the usual cut-off behavior while the side facing the wall may provide light at all vertical angles so as to uniformly illuminate the wall. FIG. 13 shows an embodiment in which a male linear large-scale prism is constructed of two symmetric halves: wall-side prism 1305 and room-side prism 1310. Specular vertical mirror 1330 can be disposed between the two prisms. Mirror 1330 may include a double-sided reflective sheet that is inserted or co-extruded between the two prisms. Mirror 1330 might also be created via vacuum-metallization of the adjacent vertical prism faces forming the center seam.

The bases of the two halves can couple differently with patterning lens 1315 (or a light source). That is, room-side prism 1310 can include air gap 1312 between the base of room-side prism 1310 and patterning lens 1315. Wall-side prism 1305, on the other hand, can be optically coupled to patterning lens 1315 to eliminate any air gap that would support TIR at the interface. Wall side prism 1305, for example, can be optically coupled to patterning lens 1315 with index matching optical cement or gel, sonic welding, and/or forming patterning lens 1315 and wall-side prism 1305 as a single part. In this configuration some light that exits room-side prism 1310 may undergo TIR when viewed at large angles from nadir while light that exits wall-side prism 1305 may not undergo TIR. Eliminating TIR at the interface can allow wall-side prism 1305 to emit light toward the wall at all vertical angles.

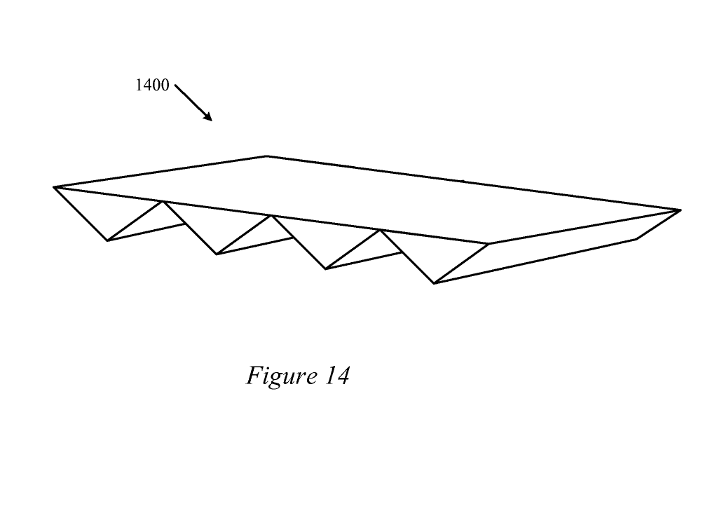

FIG. 14 shows prismatic array 1400 that includes a plurality of male, linear, large-scale prisms according to some embodiments of the invention. While linear large-scale prisms are shown, any type(s) of large-scale prisms can be used. Moreover, the prisms can be arranged in any type of arrangement, pattern, or array. For example, a two dimensional array of conical or pyramidal prisms can be arranged in an array. Moreover, the prisms of different types can also be used together in the same array. Prismatic array 1400 can also include a plurality of prisms (or other shapes) where each prism is separate from one another and/or includes discreet prims.

In some embodiments, the unique photometric and visual properties of the optical engine detailed above are meant to provide controlled high-angle illumination while striking a balance in terms of luminous contrast and visual dynamics that not muted or static, but also not glary or visually noisy. Alternatively stated, an ideal embodiment of the invention would be visually interesting without being visually distracting. The luminous composition and dynamics of a great deal of commercial lighting equipment tends to be conservative to the point of potential dullness and/or unrefined to the point of potential unattractiveness. On the other end of the spectrum, the dynamic sparkle of a well-designed chandelier can serve as an excellent focal point in very specific settings while having visual qualities that are far too extreme and decorative for most commercial applications. Luminaires based on the disclosed invention can provide a middle ground between these extremes in terms of aesthetics, architectural integration and visual experience.

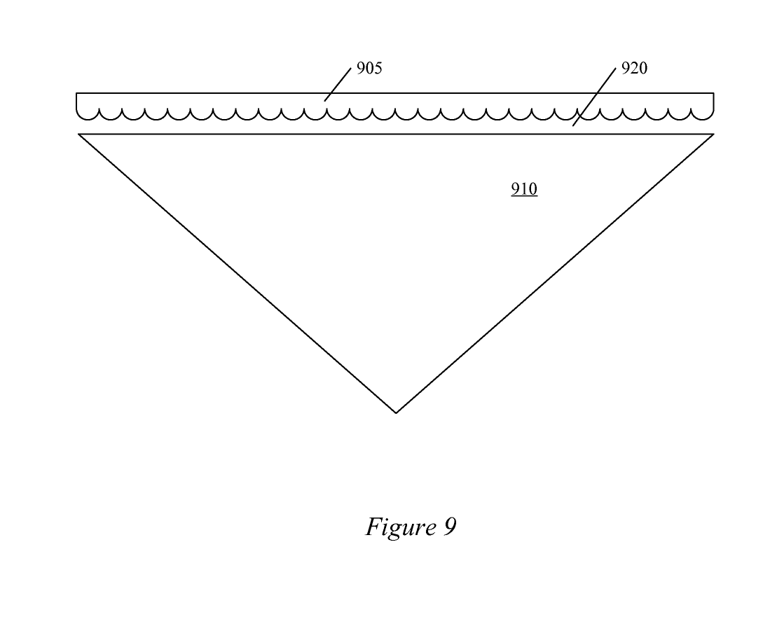

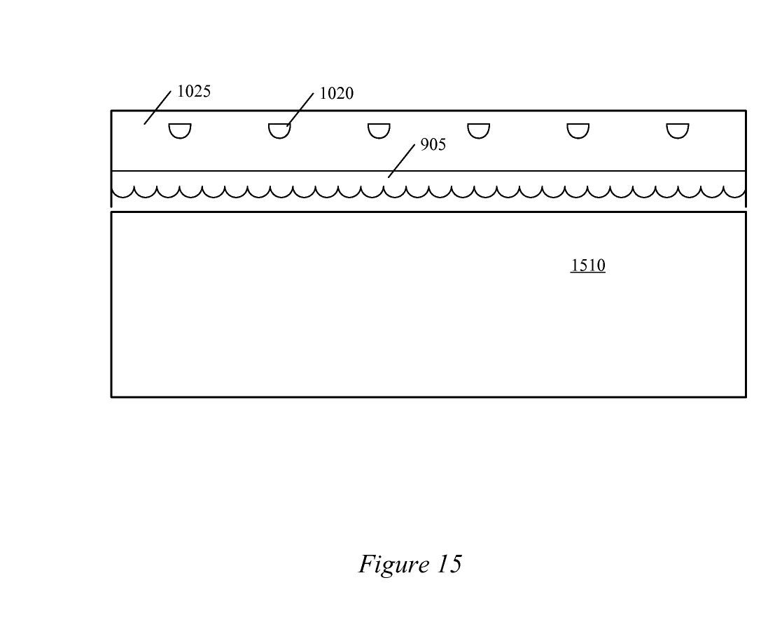

FIG. 15 shows a side-view of a large-scale cuboid (a solid object with 6 rectangular faces) with a ribbed refractor according to some embodiments of the invention. This light engine is similar to that shown in FIG. 9 with prism 910 replaced with cuboid 1510. In this embodiment, cuboid 1510 may not provide the same highly defined cut-off behavior as prism 910, but high angle glare control can be achieved via Fresnel reflections. Cuboid 1510 can be a solid mostly transmissive element. Moreover, a visual appearance can be achieved that is similar to the prismatic embodiments such as those shown in FIG. 9. In some embodiments, cuboid 1510 can have all, some, one, or a majority of polished, clean, and/or clear faces. In some embodiments, cuboid 1510 may not include frosted faces and/or may not include a visually patterned diffuser to display a luminous pattern through a clear face. Moreover, cuboid 1510 may leave some faces flashed and others unflashed.

Moreover, embodiments of the invention also include large-scale shapes that have one or more vertically extruded cross-section. For example, a cross section of a rectangle, square, circle, oval, polygon, etc. can be extruded in optical material to have a vertical profile. Cuboid 1510, for example, represents a single vertically extruded rectangle. Embodiments of the invention include vertical extrusions with any cross-section shape as well as any number of extrusions. These extrusions can be extruded from any type of optical material including glass, plastic, etc.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A luminaire comprising:
a light source;
a large-scale prism having a base surface and at least one other surface, wherein the large-scale prism is positioned near the light source such that light from the light source passes through the base surface, and wherein the large-scale prism luminaire comprises an air gap disposed between the large-scale prism and the light source; and
an attachment mechanism that attaches the luminaire to a ceiling.

2. The luminaire according to claim 1, wherein the luminaire comprises a single large-scale prism.

3. The luminaire according to claim 1, wherein the luminaire comprises a patterning lens disposed between the light source and the single large-scale prism.

4. The luminaire according to claim 1, wherein the large-scale prism has at least one dimension greater than one half of an inch.

5. The luminaire according to claim 1, wherein the surface area of the base surface is greater than 0.25 square inches.

6. The luminaire according to claim 1, wherein the large-scale prism comprises a conical prism or a pyramid-shaped prism.

7. The luminaire according to claim 1, wherein the light source comprises one or more LEDs.

8. The luminaire according to claim 1, wherein the large-scale prism comprises a linear large-scale prism comprising a length, a width and a height, wherein the length is substantially larger than both the width and the height.

9. The luminaire according to claim 8, wherein the light source comprises a plurality of LEDs arrayed in a line along the length of the large-scale prism.

10. The luminaire according to claim 1, wherein a gap is disposed between the light source and the base of the prism.

11. A luminaire comprising:
a luminaire body having a length and a width;
a plurality of LEDs disposed within the luminaire body;
a large-scale prism having a base that is coupled with the luminaire body; and
a patterning lens disposed between the plurality of LEDs and the single large-scale prism with an air gap between the patterning lens and the single large-scale prism.

12. The luminaire according to claim 11, wherein the base of the single large-scale prism has a length and a width complimentary with the length and the width of luminaire body.

13. The luminaire according to claim 12, wherein either or both the length and width of the single large-scale prism base is greater than one half of an inch.

14. The luminaire according to claim 11, wherein the large-scale prism comprises a spherical prism, a linear prism, or a pyramid-shaped prism.

15. The luminaire according to claim 11, wherein the large-scale prism comprises a female large-scale prism.

16. A luminaire comprising:
a first large-scale prism comprising at least three faces;
a second large-scale prism comprising at least three faces;
a double sided mirror disposed between and coupled with one face of the first large-scale prism and one face of the second large-scale prism; and
an optical element optically coupled with a face of the first large-scale prism and not optically coupled with a face of the second large-scale prism.

17. The luminaire according to claim 16, further comprising a plurality of light sources disposed near the first large-scale prism and the second large-scale prism.

18. The luminaire according to claim 16, wherein the first large-scale prism and the second large-scale prism are linear prisms.

19. The luminaire according to claim 16, wherein the optical element extends along the base of the second large-scale prism but is not in contact with the second large-scale prism.

20. The luminaire according to claim 16, further comprising a light source disposed near the optical element and configured to direct light through the optical element and the first large-scale prism and the second large-scale prism.

21. A luminaire comprising:
a luminaire body having a length and a width;
a plurality of LEDs disposed within the luminaire body;
a solid of optical material having a cross-sectional base that is coupled with the luminaire body, wherein the solid is non-patterned on a majority of its faces; and
a patterning lens disposed between the plurality of LEDs and the solid with an air gap between the patterning lens and the solid.

22. The luminaire according to claim 21, wherein the solid comprises one or more cuboids.

23. The luminaire according to claim 21, wherein the cross-sectional base of the solid comprise a square cross-section, a rectangular cross-section, a triangular cross-section, a polygonal cross-section, a circular cross-section, or an oval cross section.

24. The luminaire according to claim 21, wherein the solid comprises a plurality of solids.
